(19) United States
(12) Patent Application Publication
(10) Pub. No.: US 2026/0112680 A1
(43) Pub. Date: Apr. 23, 2026

(54) BATTERY CELL FOLDING SYSTEM

(71) Applicant: SK ON CO., LTD., Seoul (KR)

(72) Inventors: Seung Hyeon CHEON, Daejeon (KR); Seung Won CHOI, Daejeon (KR)

(21) Appl. No.: 19/361,000

(22) Filed: Oct. 17, 2025

(30) Foreign Application Priority Data
Oct. 18, 2024 (KR) 10-2024-0142653

(51) Int. Cl. H01M 10/04; H01M 50/105

(52) U.S. Cl. CPC H01M 10/0404; H01M 50/105

(57) ABSTRACT

A folding system of a battery cell including an accommodation portion accommodating an electrode assembly and a sealing portion extending outwardly from the accommodation portion includes a cell support portion disposed below the sealing portion to support the sealing portion and a cell pressing portion moving, while pressing an upper surface of the sealing portion, to form a pre-folding line in the sealing portion, wherein the cell pressing portion includes a pressing wheel rolling, while pressing the upper surface of the sealing portion.

### CROSS-REFERENCE TO RELATED APPLICATION(S)

This patent document claims the priority and benefits of Korean Patent Application No. 10-2024-0142653 filed on Oct. 18, 2024, the disclosure of which is incorporated herein by reference in its entirety.

### TECHNICAL FIELD

The disclosure and implementations disclosed in this patent document generally relate to a battery cell folding system.

### BACKGROUND

Unlike primary batteries, secondary batteries may be charged with and discharged of electricity, and thus, may be applied to devices within various fields, such as digital cameras, mobile phones, laptops, hybrid vehicles, and electric vehicles. Recently, active research has been conducted on lithium secondary batteries having high energy density and high discharge voltage.

Loading secondary batteries into vehicles requires improving energy density and overcoming spatial constraints. To address this, wide-width battery cells, in which the length of an edge between electrode tabs is significantly longer than the length of an edge in which each electrode tab is located, have been proposed.

However, wide-width battery cells have a problem in that a sealing portion sealing a pouch is lengthened, resulting in an uneven folding width of the sealing portion during a process of folding the sealing portion.

### SUMMARY

The present disclosure may be implemented in some embodiments to provide a battery cell folding system capable of reducing meandering during a battery cell folding process and maintaining a uniform folding width.

A battery device manufactured using the battery cell folding system of the present disclosure may be widely applied to devices within green technology fields, such as electric vehicles, battery charging stations, and other solar and wind power generation using batteries. Furthermore, the battery device may be used in eco-friendly electric vehicles, hybrid vehicles, and other vehicles preventing climate change by reducing air pollution and greenhouse gas emissions.

In some embodiments of the present disclosure, a folding system of a battery cell including an accommodation portion accommodating an electrode assembly and a sealing portion extending outwardly from the accommodation portion includes: a cell support portion disposed below the sealing portion to support the sealing portion; and a cell pressing portion moving, while pressing an upper surface of the sealing portion, to form a pre-folding line in the sealing portion, wherein the cell pressing portion includes a pressing wheel rolling, while pressing the upper surface of the sealing portion.

The cell support portion may include a heating portion heating a support surface supporting the sealing portion.

The cell support portion may include an insertion groove formed along a movement path of the pressing wheel, and the pressing wheel may include a pressing protrusion inserted into the insertion groove.

The pressing wheel may include a body portion formed to have a cylindrical shape and pressing the sealing portion, and the pressing protrusion may be formed to protrude in a radial direction from an outer circumferential surface of the body portion.

The cell pressing portion may further include: a shaft inserted into the pressing wheel to form a rotating shaft of the pressing wheel; and a driving unit coupled to the shaft to move the shaft.

The driving unit may include: an up-down driving unit moving the shaft in an up-and-down direction; and a front-rear driving unit moving the shaft in a direction, parallel to the insertion groove.

The folding system may further include: a heat source coupled to the shaft and supplying heat to the pressing wheel via the shaft; a temperature sensor measuring a temperature of the shaft; and a controller controlling an operation of the heat source based on the temperature measured by the temperature sensor.

The folding system may further include: a cell fixing portion disposed in an upper portion of the battery cell so as to be movable in an up-down direction and pressing the battery cell to suppress movement of the battery cell.

The cell fixing portion may include: a pressing block disposed parallel to the insertion groove and pressing the battery cell between the electrode assembly and the insertion groove; and a driving unit moving the pressing block in the up-down direction.

The pressing block may be disposed so that a pressing surface pressing the battery cell faces the cell support portion, and the battery cell may be restrained from moving as a portion of the sealing portion or the accommodation portion may be caught between the pressing block and the cell support.

The folding system may further include: a controller controlling the cell fixing portion to fix the battery cell and then controlling the cell pressing portion to form the pre-folding line.

### BRIEF DESCRIPTION OF DRAWINGS

Certain aspects, features, and advantages of the present disclosure are illustrated by the following detailed description with reference to the accompanying drawings.

FIG. 1 is a plan view of a battery cell according to an embodiment of the present disclosure;

FIG. 2 is an exploded perspective view of the battery cell illustrated in FIG. 1;

FIG. 3 is a perspective view schematically illustrating a folding system according to the present embodiment;

FIG. 4 is a side view of FIG. 3;

FIGS. 5 to 9 are diagrams illustrating an operation of a folding system; and

FIG. 10 is a side view of a folding system according to another embodiment of the present disclosure.

### DETAILED DESCRIPTION

Hereinafter, the present disclosure will be described in detail with reference to the accompanying drawings. However, these are merely exemplary, and the present disclosure is not limited to the specific embodiments described herein.

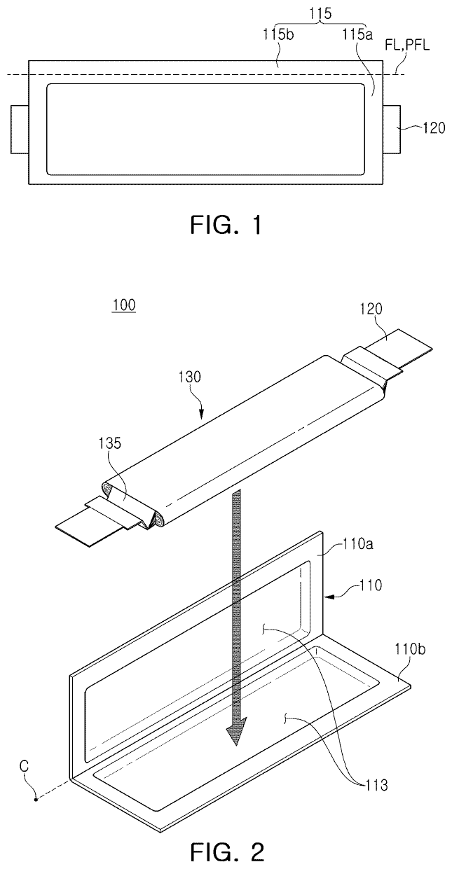

FIG. 1 is a plan view of a battery cell according to an embodiment of the present disclosure, and FIG. 2 is an exploded perspective view of the battery cell illustrated in FIG. 1.

Referring to FIGS. 1 and 2, a battery cell 100 manufactured using a folding system according to the present embodiment may include an electrode assembly 130 and a case 110 accommodating the electrode assembly 130.

The battery cell 100 according to the present embodiment is a rechargeable battery and may include a lithium-ion (Li-ion) battery or a nickel metal hydride (Ni-MH) battery. The nickel metal hydride battery is a battery cell using nickel in a positive electrode, a hydrogen storage alloy in a negative electrode, and an alkaline aqueous solution as an electrolyte. Since the nickel metal hydride battery has a large capacity per unit volume, it may be used as an energy source for electric vehicles (EVs) and hybrid electric vehicles (HEVs), as well as in various fields, such as energy storage.

The electrode assembly 130, a portion in which a plurality of electrodes are stacked, may have a roughly hexahedral shape and may be accommodated in an accommodation portion 113 of the case 110 along with an electrolyte.

The case 110 may be formed of a flexible film material. For example, the case may be formed of a material in which a surface of a metal film formed of aluminum is insulated.

The case 110 may be provided with the housing 113 on the inside, in which the electrode assembly 130 is accommodated. Also, an electrode lead 120 may be protruded to the outside of the case 110.

As illustrated in FIG. 2, in the battery cell 100 of the present embodiment, a single sheet of outer casing may be folded and then three sides thereof may be bonded to seal the accommodation portion 113. Therefore, the case 110 of the present embodiment may be divided into a first case 110a and a second case 110b based on the bending line C along which the outer casing is folded.

Specifically, the battery cell 100 of the present embodiment may be manufactured by accommodating £ the electrode assembly 130 in the accommodation portion 113, folding the outer casing along the bending line C, and then bonding the edges in which the first case 110b and the second case 110a meet to seal the accommodation portion 113.

The edge bonding method may be a heat fusion method, but is not limited thereto. Hereinafter, the bonded edge region, i.e., the bonded region extending outwardly from the accommodation portion 113, is referred to as the sealing portion 115.

In the present embodiment, the sealing portion 115 may be divided into a first sealing portion 115a, formed in a portion in which the electrode lead 120 is disposed, and a second sealing portion 115b, formed in a portion in which the electrode lead 120 is not disposed.

Meanwhile, the battery cell 100 of the present embodiment may have a space for forming the accommodation portion 113 in each of the first case 110a and the second case 110b. However, the configuration of the present disclosure is not limited thereto, and various modifications may be made, such as providing the space in only one of the first case 110a and the second case 110b.

Furthermore, an electrode tab 135 may be disposed between the electrode assembly 130 and the sealing portion 115. The electrode tab 135 may electrically connect the electrode assembly 130 to the electrode lead 120. A plurality of electrode tabs 135 may extend from the electrode assembly 130 and be bonded to at least one electrode lead 120.

The electrode lead 120 may include a positive electrode lead and a negative electrode lead. At least a portion of the electrode lead 120 may protrude to the outside of the case 110, and the electrode assembly 130 may be electrically connected to external elements through the electrode lead 120.

The battery cell 100 configured in this manner may be manufactured by forming the accommodation portion 113 in the case 110 through press processing or the like, receiving the electrode assembly 130 in the accommodation portion 113, and then sealing the accommodation portion 113.

Meanwhile, to minimize the volume of the battery cell 100, the second sealing portion 115b is folded at least once.

However, as the length of the battery cell 100 increases, a difference in elongation may occur between both end portions and the center of the second sealing portion 115b, which may cause the second sealing portion 115b to be folded out of alignment with a reference line (FL of FIG. 1) intended for folding.

Considering this, the folding system according to the present disclosure forms a pre-folding line (PFL, folding line) along the reference line FL in the second sealing portion 115b, and then folds the second sealing portion 115b along the pre-folding line PFL. In the present embodiment, the pre-folding line PFL may refer to a mark formed by applying pressure to the second sealing portion 115b along the reference line FL before folding the second sealing portion 115b. The pre-folding line PFL may be formed with a reduced thickness, as compared to other portions of the second sealing portion 115b, or may be formed with one surface of the second sealing portion 115b concave and the other surface convexly protruding.

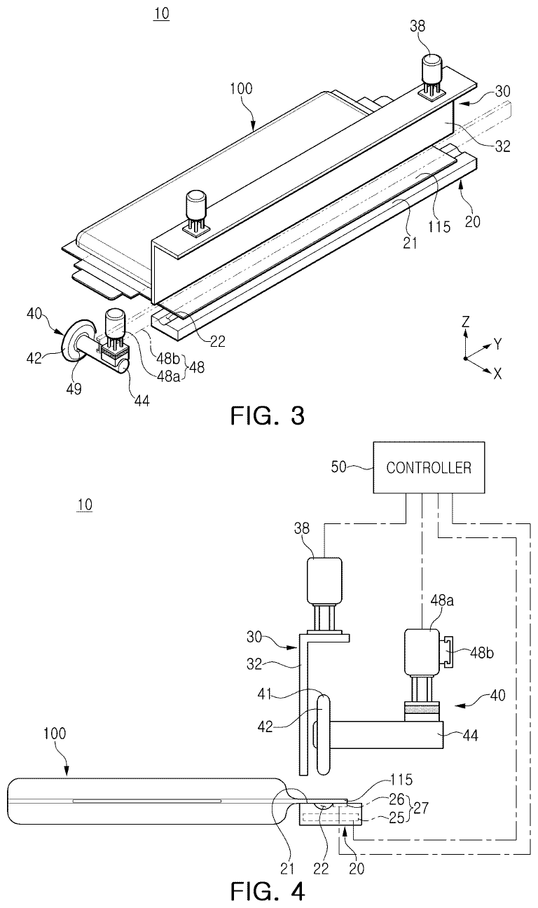

FIG. 3 is a perspective view schematically illustrating a folding system according to the present embodiment, and FIG. 4 is a side view of FIG. 3. For convenience of description, a controller is illustrated only in FIG. 4.

Referring to FIGS. 3 and 4, a folding system 10 according to the present embodiment is a folding system for the battery cell 100 including the accommodation portion 113 accommodating the electrode assembly 130 and the sealing portion 115 extending outwardly from the accommodation portion 113. The folding system includes a cell support portion 20 disposed below the sealing portion 115 to support the sealing portion 115 and a cell pressing portion 40 moving, while pressing an upper surface of the sealing portion 115, to form a pre-folding line in the sealing portion 115. The cell pressing portion 40 may include a pressing wheel 42 rolling, while pressing the upper surface of the sealing portion 115.

In the following description, the sealing portion 115 basically refers to the second sealing portion 115b.

The cell support portion 20 may be disposed below the sealing portion 115 to support the sealing portion 115. To this end, the cell support portion 20 may include a flat support surface 21, and the sealing portion 115 may be mounted on the support surface 21 of the cell support portion 20.

At least one insertion groove 22 may be formed in the support surface 21. The insertion groove 22 is disposed along a movement path of the pressing wheel 42, to be described below, i.e., the pre-folding line PFL of the sealing portion 115. Therefore, the insertion groove 22 may be formed as a linear groove.

Furthermore, the cell support portion 20 may include a first heating portion 27 heating the support surface 21. The first heating portion 27 may be provided to supply heat to the sealing portion 115 mounted on the cell support portion 20. To this end, the first heating portion 27 may include at least one heat source 25, which may be disposed within the cell support portion 20 to supply heat to the entire support surface 21 of the cell support portion 20. The heat source 45 constituting the first heating portion 27 may be an electric heat device, such as a microheater, but is not limited thereto.

Also, to maintain a constant temperature of the sealing portion 115, the first heating portion 27 may include a temperature sensor 26. The temperature sensor 26 may be attached to the support surface 21 or disposed in contact with the sealing portion 115.

The first heating portion 27 may supply heat to the sealing portion 115 under the control of the controller 50 to be described below. Furthermore, the controller 50 may control the operation of the heat source 25 based on the temperature measured by the temperature sensor 26.

The cell pressing portion 40 is disposed above the sealing portion 115 and may press the sealing portion 115. To this end, the cell pressing portion 40 may include a pressing wheel 42, a shaft 44 inserted into the pressing wheel 42 to form a rotating shaft of the pressing wheel 42, and a first driving unit 48 coupled to the shaft 44 to move the shaft 44.

The pressing wheel 42 may be formed in a disc shape and may press the sealing portion 115 to form the pre-folding line. To this end, the pressing wheel 42 may include a pressing protrusion 41 pressing the sealing portion 115 to form the pre-folding line PFL.

The pressing wheel 42 of the present embodiment may include a pressing protrusion 41 inserted into the insertion groove 22 to form the pre-folding line PFL in the sealing portion 115. The pressing protrusion 41 may protrude along the circumference of the pressing wheel 42, and at least a portion thereof may be formed in a form that may be inserted into the insertion groove 22. In the present embodiment, the entire outer periphery of the pressing wheel 42 is formed as the pressing protrusion 41. However, the present disclosure is not limited thereto and may be variously modified as in other embodiments described below.

The shaft 44 may be fastened to an inner center of the pressing wheel 42. To this end, a through-hole may be formed in the pressing wheel 42.

The shaft 44 may be inserted into the through-hole of the pressing wheel 42 and coupled to the pressing wheel 42. The shaft 44 may be used as a rotating shaft of the pressing wheel 42. Therefore, the pressing wheel 42 may be coupled to the shaft 44 so that it may rotate around the shaft 44.

To reduce friction with the shaft 44 when the pressing wheel 42 rotates, a bearing 49 may be disposed in the through-hole of the shaft 44. For example, the outer circumference 41 the bearing 49 may be coupled to the pressing wheel 42, and the inner circumference of the bearing 49 may be coupled to the shaft 44. The bearing 49 of the present embodiment may be any of a variety of known bearings, such as a ball bearing and a roller bearing.

One end of the shaft 44 may be coupled to the pressing wheel 42, and the other end may be coupled to the first driving unit 48. Therefore, the shaft 44 and the pressing wheel 42 may move in accordance with the driving of the first driving unit 48.

The first driving unit 48 may reciprocate the shaft 44 in the up-down and forward-backward directions. To this end, the first driving unit 48 may include an up-down driving unit 48a reciprocating the shaft 44 in an up-down direction (the Z-direction) and a front-rear driving unit 48b reciprocating the shaft 44 in a first direction (the Y-direction). Here, the first direction refers to a direction, parallel to the insertion groove 22. To move the shaft 44, the up-down driving unit 48a and the front-rear driving unit 48b may include known driving devices, such as a motor or a pneumatic/hydraulic cylinder.

The pressing wheel 42 may be lowered by the up-down driving unit 48a to press the sealing portion 115. During this process, the pressing protrusion 41 of the pressing wheel 42 or the sealing portion 115 pressed by the pressing protrusion 41 may be inserted, at least partially, into the insertion groove 22. Furthermore, the pressing wheel 42 may move in the first direction, while maintaining the pressure on the sealing portion 115 by the front-rear driving unit 48b.

In the present embodiment, the shaft 44 may be connected to the up-down driving unit 48a, and the front-rear driving unit 48b may be connected to the up-down driving unit 48a. In this case, the up-down driving unit 48a may move in the forward/backward direction together with the shaft 44. However, the present disclosure is not limited thereto, and various modifications may be made, such as configuring the shaft 44 to be connected to the front-rear driving unit 48b and the up-down driving unit 48a to be connected to the front-rear driving unit 48b.

The cell fixing portion 30 is disposed in an upper portion of the sealing portion 115 so as to be movable in an up-down direction and may press the battery cell 100 to suppress movement of the battery cell. To this end, the cell fixing portion 30 may include a pressing block 32 disposed parallel to the insertion groove 22 and pressing the battery cell 100 between the electrode assembly 130 and the insertion groove 22 and a second driving unit 38 moving the pressing block 32 in the up-down direction.

The pressing block 32 may be disposed perpendicular to the sealing portion 115 mounted on the cell support portion 20, and a lower end surface, which is a pressing surface for the battery cell 100, may be disposed to face the support surface 21 of the cell support portion 20. Therefore, when the pressing block 32 is lowered and presses the battery cell 100, a portion of the sealing portion 115 or the accommodation portion 113 is caught between the lower end surface of the pressing block 32 and the support surface 21 of the cell support portion 20, so that movement of the battery cell 100 may be restrained.

The cell fixing portion 30 may be provided to restrain the movement of the sealing portion 115 in the process of forming the pre-folding line PFL. Therefore, the battery cell 100 may be pressed with a pressure within a range in which the sealing portion 115 does not move during the movement of the pressing wheel 42.

The pressing block 32 may be disposed spaced apart from the pressing wheel 42 by a predetermined distance and parallel to the insertion groove 22. For example, the pressing block 32 may be disposed between the electrode assembly 130 of the battery cell 100 and the insertion groove 22 to press the battery cell 100. Furthermore, the pressing block 32 may be formed to be longer than the battery cell 100 in the first direction, thereby pressing even both end portions of the sealing portion 115 in the first direction.

The second driving unit 38 may reciprocate the pressing block 32 in the vertical direction. To move the pressing block 32, the second driving unit 38 may include a known driving device, such as a motor or a pneumatic/hydraulic cylinder.

The pressing block 32 may be lowered by the second driving unit 38 to press the sealing portion 115. During this process, the sealing portion 115 of the battery cell 100 may be caught between the lower end surface of the pressing block 32 and the support surface 21 of the cell support portion 20 so as to be restrained from moving.

The controller 50 may control the cell fixing portion 30 to fix the battery cell 100 and then control the cell pressure portion 40 to form the pre-folding line PFL.

As illustrated in FIG. 4, the controller 50 may be connected to the first driving unit 48 and the second driving unit 38 and may control the operations of the first driving unit 48 and the second driving unit 38. For example, the controller 50 may control the second driving unit 38 to lower the pressing block 32 until the pressing block 32 presses the sealing portion 115. When the battery cell 100 is secured by the pressing block 32, the controller 50 may control the first driving unit 48 to lower the pressing wheel 42 or move the pressing wheel 42 in the first direction.

Furthermore, when the pre-folding line PFL is formed in the sealing portion 115 of the battery cell 100, the controller 50 may control the first driving unit 48 and the second driving unit 38 to return the pressing block 32 and the pressing wheel 42 to their original positions.

As described above, the controller 50 may also control the first heating portion 27 to adjust heat applied to the sealing portion 115.

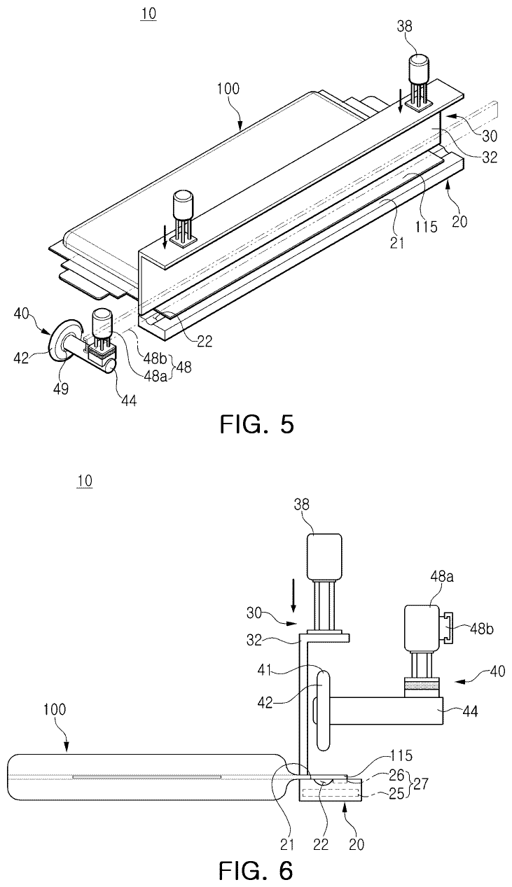

FIGS. 5 to 9 are diagrams illustrating the operation of the folding system. A folding method using the folding system according to the present embodiment will be described with reference to these drawings,

First, as illustrated in FIGS. 3 and 4, the sealing portion 115 of the battery cell 100 is disposed on the cell support portion 20. The sealing portion 115 may be disposed on the support surface 21 of the cell support portion 20 such that a lower surface thereof may be supported by the cell support portion 20. Here, the sealing portion 115 may be disposed to cover the insertion groove 22 of the cell support portion 20.

Heat supplied from a first heating portion 47 may be transferred to the sealing portion 115 mounted on the cell support portion 20. Accordingly, the temperature of the sealing portion 115 may be changed to a temperature suitable for forming a folding line.

Subsequently, the controller 50 may control the second driving unit 38 to lower the pressing block 32. As illustrated in FIGS. 5 and 6, the pressing block 32 may press the sealing portion 115 with a preset pressure, so that the battery cell 100 may be caught by the pressing block 32 and the cell support portion 20 so as to be restrained from moving.

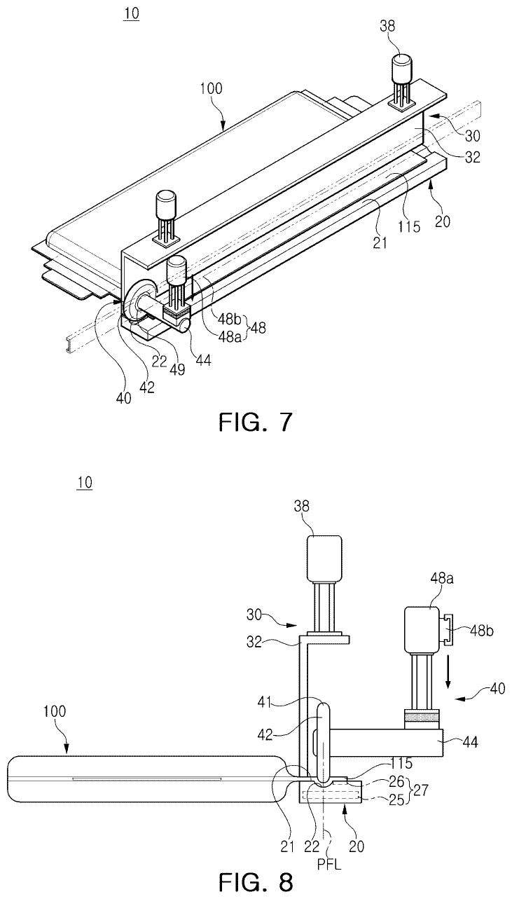

Subsequently, as illustrated in FIGS. 7 and 8, the controller 50 may control the up-down driving unit 48a of the first driving unit 48 to lower the pressing wheel 42. Here, a portion of the pressing protrusion 41 of the pressing wheel 42 may be inserted into the insertion groove 22 of the cell support portion 20 or disposed very close to the insertion groove 22.

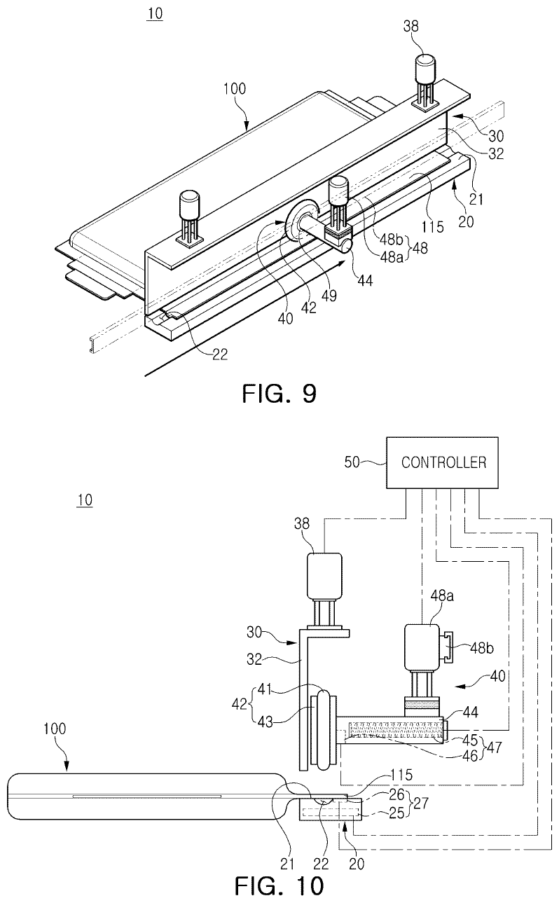

Subsequently, as illustrated in FIG. 9, the controller 50 may control the front-rear driving unit 48b of the second driving unit 38 to move the pressing wheel 42 in the first direction. In this process, the pressing wheel 42 passes over an upper portion of the sealing portion 115, and the pressing protrusion 41 of the pressing wheel 42 moves along the insertion groove 22, while pressing the sealing portion 115. Here, the pressing wheel 42 rotates around the shaft 44 as a rotating shaft and moves in the first direction, and the pre-folding line PFL is formed along the insertion groove 22 at a location in which the pressing wheel 42 has passed in the sealing portion 115.

When the pressing wheel 42 moving in the first direction leaves the sealing portion 115, the controller 50 may sequentially return the pressing wheel 42 and the pressing block 32 to their original positions.

Once the pre-folding line PFL is formed through this process, the sealing portion 115 may be folded using a folding device. During this process, the folding device may fold the sealing portion 115 along the pre-folding line PFL. Any of a variety of known folding devices may be used as the folding device.

The folding system 10 of the present embodiment, configured as described above, may form the pre-folding line PFL by applying heat to the sealing portion 115, thereby enhancing the formability of the sealing portion 115, and accordingly, the pre-folding line PFL may be easily formed. Furthermore, the folding system 10 of the present embodiment applies heat to the sealing portion 115 only through the cell support t portion 20. Therefore, a phenomenon that excessive heat is supplied to the sealing portion 115 to increase a difference in elongation so that the pre-folding line PFL is misaligned with the reference line FL may be suppressed.

Furthermore, since the pre-folding line PFL is formed while the battery cell 100 is secured using the cell fixing portion 30, movement of the battery cell 100 during the pre-folding line formation process may be suppressed. Therefore, the pre-folding line PFL may be formed more accurately.

Hereinafter, other embodiments of the present disclosure are additionally described. These are illustrative only and do not limit the scope of the appended claims. It will be apparent to those skilled in the art that various modifications and variations may be made within the scope and spirit of the present disclosure, and such modifications and variations are also within the scope of the appended claims.

FIG. 10 is a side view of a folding system according to another embodiment of the present disclosure.

Referring to FIG. 10, the folding system according to the present embodiment is configured to be similar to the previously described embodiment and may further include a second heating portion 47.

The second heating portion 47 may include a heat source 45 coupled to the shaft 44 to supply heat to the pressing wheel 42 via the shaft 44 and a temperature sensor 46 measuring the temperature of the shaft 44. The controller 50 may control the operation of the heat source 45 based on the temperature measured by the temperature sensor 46. Accordingly, the second heating portion 47 may heat the shaft 44 under the control of the controller 50.

The second heating portion 47 may include at least one heat source 45, which may be disposed within the shaft 44 to supply heat to the pressing wheel 42. In this case, heat may be concentrated on a region in which the pre-folding line PFL is formed, thereby minimizing unnecessary stretching of the sealing portion 115 due to heat applied to other regions of the sealing portion 115.

The heat source 45 of the second heating portion 47 may be an electric heating device, such as a micro heater, but is not limited thereto.

Furthermore, to maintain a constant temperature of the pressing wheel 42, the second heating portion 47 may include the temperature sensor 46. The temperature sensor 46 may be attached to the pressing wheel 42. In this case, however, the wiring of the temperature sensor 46 may be complicated, and thus, in the present embodiment, the temperature sensor 46 is attached to the shaft 44. The temperature sensor 46 may also be disposed in contact with the bearing 49, if necessary.

Heat generated by the heat source 45 may be transferred to the pressing protrusion 41 of the pressing wheel 42 via the shaft 44 and bearing 49 and may then be transferred to the sealing portion 115 in contact with the pressing protrusion 41.

The second heating portion 47 may supply heat to the sealing portion 115 under the control of the controller 50. For example, the controller 50 may control the heat source 45 to supply a corresponding amount of heat to the shaft 44 based on the amount of heat required to be transferred to the sealing portion 115. Furthermore, the operation of the heat source 45 may be controlled based on the temperature measured by the temperature sensor 46. In this case, the bearing 49 may be a bearing with high heat resistance and thermal conductivity.

Furthermore, the pressing wheel 42 of the present embodiment may be formed in a roller shape. For example, the pressing wheel 42 may include a cylindrical body portion 43 pressing the sealing portion 115 and the pressing protrusion 41 protruding in a radial direction from an outer circumferential surface of the body portion 43. In the present embodiment, the pressing protrusion 41 may protrude outwardly from a region corresponding to the insertion groove 22 when the pressing wheel 42 presses the sealing portion 115.

In this case, when the pressing protrusion 41 presses the sealing portion 115, the body portion 43 near the pressing protrusion 41 presses the sealing portion 115, and accordingly, when the sealing portion 115 is pressed by the pressing protrusion 41, the sealing portion 115 near the pre-folding line may be prevented from lifting.

The above description is merely an example of applying the principles of the present disclosure, and other components may be included without departing from the scope of the present disclosure. For example, in the aforementioned embodiments, a single pre-folding line is formed. However, the present disclosure is not limited thereto, and various modifications may be made, such as configuring a plurality of pressing wheels to simultaneously form a plurality of pre-folding lines or configuring a single pressing wheel to include a plurality of pressing protrusions to simultaneously form a plurality of pre-folding lines.

According to an embodiment of the present disclosure, the folding width may be maintained uniformly during the battery cell folding process.

Only specific examples of implementations of certain embodiments are described. Variations, improvements and enhancements of the disclosed embodiments and other embodiments may be made based on the disclosure of this patent document.

1. A folding system of a battery cell including an accommodation portion accommodating an electrode assembly and a sealing portion extending outwardly from the accommodation portion, folding system comprising:
a cell support portion disposed below the sealing portion to support the sealing portion; and
a cell pressing portion moving, while pressing an upper surface of the sealing portion, to form a pre-folding line in the sealing portion,
wherein the cell pressing portion includes a pressing wheel rolling, while pressing the upper surface of the sealing portion.

2. The folding system of claim 1, wherein the cell support portion includes a heating portion heating a support surface supporting the sealing portion.

3. The folding system of claim 1, wherein the cell support portion includes an insertion groove formed along a movement path of the pressing wheel, and the pressing wheel includes a pressing protrusion inserted into the insertion groove.

4. The folding system of claim 3, wherein the pressing wheel includes a body portion formed to have a cylindrical shape and pressing the sealing portion, and the pressing protrusion is formed to protrude in a radial direction from an outer circumferential surface of the body portion.

5. The folding system of claim 4, wherein
the cell pressing portion further includes:
a shaft inserted into the pressing wheel to form a rotating shaft of the pressing wheel; and
a driving unit coupled to the shaft to move the shaft.

6. The folding system of claim 5, wherein
the driving unit includes:
an up-down driving unit moving the shaft in an up-and-down direction; and
a front-rear driving unit moving the shaft in a direction, parallel to the insertion groove.

7. The folding system of claim 5, further comprising:
a heat source coupled to the shaft and supplying heat to the pressing wheel via the shaft;
a temperature sensor measuring a temperature of the shaft; and
a controller controlling an operation of the heat source based on the temperature measured by the temperature sensor.

8. The folding system of claim 3, further comprising a cell fixing portion disposed in an upper portion of the battery cell so as to be movable in an up-down direction and pressing the battery cell to suppress movement of the battery cell.

9. The folding system of claim 8, wherein
the cell fixing portion includes:
a pressing block disposed parallel to the insertion groove and pressing the battery cell between the electrode assembly and the insertion groove; and
a driving unit moving the pressing block in the up-down direction.

10. The folding system of claim 9, wherein
the pressing block is disposed so that a pressing surface pressing the battery cell faces the cell support portion, and
the battery cell is restrained from moving as a portion of the sealing portion or the accommodation portion is caught between the pressing block and the cell support.

11. (canceled)
